(19) United States
(12) Patent Application Publication
(10) Pub. No.: US 2012/0234889 A1
(43) Pub. Date: Sep. 20, 2012

(54) DENTAL FLOSS CASING

(75) Inventor: Yun soon KIM, Duluth, GA (US)

(73) Assignees: DENTSOLL KOREA CO., LTD., Jangseong-Gun (KR); Yun soon Kim, Duluth, GA (US)

(21) Appl. No.: 13/325,766

(22) Filed: Dec. 14, 2011

Related U.S. Application Data
(63) Continuation-in-part of application No. PCT/KR2011/007794, filed on Oct. 19, 2011.

(30) Foreign Application Priority Data
Mar. 14, 2011 (KR) 10-2011-0022383

(51) Int. Cl. A61C 15/04; B65D 85/04

(52) U.S. Cl. 225/17; 225/38

(57) ABSTRACT

A dental floss casing includes a bobbin fixer fixing therein a bobbin around which the thread of dental floss is wound, a transparent window coupled thereto to allow the state of the bobbin fitted in the bobbin fixer to be checked, front and rear covers detachably coupled to each other, a dental floss-drawing section provided in one side of the front or rear cover such that the thread of dental floss wound around the bobbin is drawn to the outside therethrough, and a dental floss cutter provided adjacent to one side of the front or rear cover to cut the thread of dental floss that is drawn.

### BACKGROUND OF THE INVENTION

1. Field of the Invention

The present invention relates, in general, to a dental floss casing and, more particularly, to a dental floss casing in which the threads of different kind of floss are wound around two bobbins such that the threads of floss are drawn diagonal to each other, thereby improving convenience of use.

2. Description of the Related Art

Generally, dental floss is one kind of dental cleaning device used to clean the teeth and remove particles of food and dental plaque stuck between the teeth. Dental floss is effectively used either in dental treatment in a dental clinic, or to remove food particles and dental plaque stuck between the teeth after a meal, which is performed by a person who carries it. Thus, the use of dental floss is increasing.

To be used, the dental floss is contained in a small portable casing (hereinafter referred to as a “box”), which can be carried by a person, and a required length of the thread of dental floss is drawn out of the box and cut using a cutter provided in the box.

The conventional dental floss box has the structure in which one kind of dental floss, i.e. having e.g. the same thickness, fragrance, additives, or the like is wound around a bobbin, which is provided in the dental floss box in such a way that it is engaged with a bobbin fixer so that the dental floss is forcedly drawn out of the dental floss box.

However, since the interdental distance and taste may differ for each user, there is a need for a user or users to selectively use a variety kind of dental floss having different thicknesses and additives. However, the conventional dental floss box has only one kind of dental floss, so that it is inconvenient for user(s) to use it to suit to his (their) tastes or teeth structures. Because of such inconvenience, the user(s) should unavoidably carry a plurality of dental floss boxes each having a different kind of dental floss, which is a troublesome task.

Further, in the conventional dental floss box, since a bobbin fixer for fixing a bobbin around which the dental floss is wound is spaced apart from an inner circumference of a fixing hole of the bobbin, when the thread of dental floss is drawn out of the dental floss box, the bobbin engaged with the bobbin fixer is freely rotated by the drawing force generated when the thread of dental floss is drawn out, so that the thread of dental floss wound around the bobbin may be arbitrarily released, causing the thread of dental floss to either be entangled in the box or to unwind even more.

Furthermore, while the conventional dental floss box is either entirely semi-transparent or partially transparent, it is very difficult for a user to see into the dental floss box, so that checking the length of the thread of dental floss that remains around the bobbin is not possible.

### SUMMARY OF THE INVENTION

Accordingly, the present invention has been made keeping in mind the above problems occurring in the related art, and an object of the present invention is to provide a dental floss casing in which a plurality of bobbins around which the threads of different kinds of dental floss are wound is mounted, and a transparent window is provided in one side thereof so that a user can see into the box therethrough, thereby making it easy to use.

Another object of the present invention is to provide a dental floss casing which is capable of preventing a bobbin, which can rotate in a state of being fixed to the inside thereof, from idling when the thread of dental floss is unwound, thereby preventing the thread of dental floss from being entangled in the casing and preventing the plurality of threads of dental floss, which are unwound from the plurality of bobbins, from interfering with each other.

A further object of the present invention is to provide a dental floss casing in which when the thread of dental floss is drawn, it is configured for a user to hold the thread of dental floss by fingers, and which is designed such that the kinds of dental floss, wound around the bobbins in the casing, can be easily checked from the outside to make use of the casing more convenient.

In order to achieve the above objects, according to one aspect of the present invention, there is provided a dental floss casing including: a bobbin fixer fixing therein a bobbin around which the thread of dental floss was wound; a transparent window detachably coupled thereto for checking the state of the thread of dental floss wound around the bobbin from the outside; a dental floss-drawing section through which the thread of dental floss wound around the bobbin is drawn to the outside; and a dental floss cutter provided adjacent to one side of the dental floss-drawing section to cut the thread of dental floss that is drawn, wherein the bobbin fixer has a length of 3 to 5 cm such that more than one bobbin each wound with a different kind of dental floss are fitted together, and wherein the dental floss-drawing section and the dental floss cutter respectively consist of a plurality of dental floss-drawing sections and dental floss cutters.

Preferably, the structures of the dental floss-drawing section and the dental floss cutter are such that they are provided opposite to each other. The bobbin fixer has the form of a cylinder with a plurality of slits formed at regular intervals in the circumferential direction such that when the bobbin is fitted around the outer circumference of the bobbin fixer, an inner surface of a fixing hole of the bobbin comes into elastic contact with the outer circumference of the bobbin fixer in order to prevent the bobbin fitted around the outer circumference of the bobbin fixer from idling when the thread of dental floss is drawn.

In addition, the dental floss-drawing section has a cover part, an opening recess with a certain depth provided adjacent to one side of the cover part to facilitate opening of the cover part, an indicator provided adjacent to one side of the opening recess for indicating the position of opening the cover part, and a marker provided adjacent to one side of the indicator for allowing a user to identify the kind of dental floss wound around the bobbin.

Further, the bobbin fixer is provided, in the middle of the whole length thereof, with an anti-friction member for preventing friction between the plurality of bobbins fitted together therein, wherein the anti-friction member includes a planar disc which is detachably coupled around the outer circumference of the bobbin fixer, and a dividing pin which is fitted into the outer circumference of the bobbin fixer.

Further, the bobbin fixed to the bobbin fixer is provided, on opposite ends, with sidewalls, the diameter of which is larger than a diameter of the middle portion thereof, around which the thread of dental floss is wound, thereby preventing the friction, entanglement, and collapse of the threads of dental floss when they are drawn from the adjacent bobbins. Further, an anti-friction member is mounted between the plurality of bobbins.

According to the dental floss casing of the present invention, the plurality of bobbins are mounted to the inside thereof, and a different kind of dental floss is drawn out of the dental floss casing from the plurality of bobbins, so that a user can conveniently use the different kind of dental floss from a single dental floss casing.

In addition, the bobbin is elastically fitted around the bobbin fixer, so that when the thread of dental floss is drawn out of the bobbin, the bobbin is prevented from idling, thereby preventing the thread of dental floss from being excessively unwound and becoming entangled in the dental floss casing, which enables the dental floss to be conveniently used.

Further, the indicator and marker are provided in one side of the dental floss-drawing section, so that when a different kind of dental floss is used while being wound around the plurality of bobbins, a user can easily identity and use the different kind of dental floss.

Further, the bobbin is provided, on opposite ends, with sidewalls of a certain size, so that when the threads of dental floss are drawn from the adjacent bobbins, the friction, entanglement, and collapse of the threads of dental floss are prevented, thereby making it easier to use and manage.

### BRIEF DESCRIPTION OF THE DRAWINGS

The above and other objects, features and further advantages of the present invention will be more clearly understood from the following detailed description when taken in conjunction with the accompanying drawings, in which:

FIG. 1 is a frontal perspective view of a dental floss casing according to an embodiment of the present invention;

FIG. 2 is an exploded perspective view of the dental floss casing;

FIG. 3 is an enlarged view of section “C” of FIG. 2;

FIGS. 4 and 5 are views showing an anti-friction member provided to a bobbin fixer;

FIG. 6 is a view showing the state of the thread of dental floss as it is drawn from a bobbin fitted around the bobbin fixer;

FIG. 7 is a constructional view showing the state of the bobbin wound with the thread of dental floss that has been fitted around the bobbin fixer;

FIG. 8 is a view showing the state of the thread of dental floss as it is drawn out of the dental floss casing; and

FIGS. 9 and 10 are perspective views respectively showing a bobbin according to an embodiment of the invention and the state of such bobbins being mounted to the bobbin fixer.

### DETAILED DESCRIPTION OF THE INVENTION

A dental floss casing according to the present invention is configured so that a plurality of bobbins wound with dental floss is installed therein, and a plurality of dental floss-drawing sections having a cover and a cutter is provided to enable the threads of dental floss, which are drawn from the bobbins, to be drawn in directions that are different from each other.

Particularly, a bobbin fixer may have the length of 3 to 5 cm such that the plurality of bobbins, especially two bobbins, are fitted together around the bobbin fixer.

In addition, the bobbin fixer fitted with the bobbins may have the form of a cylinder with a plurality of slits formed in the circumferential direction, such that when the bobbin is fitted around the bobbin fixer, the bobbin fixer makes elastic contact, and after the bobbin is fitted, an inner surface of a fixing hole of the bobbin comes into elastic contact with the outer circumference of the bobbin fixer, thereby preventing the bobbin from idling when the thread of dental floss is drawn.

Reference will now be made in greater detail to preferred embodiments of the invention, examples of which are illustrated in the accompanying drawings. However, the illustrated embodiments may be changed and implemented in a variety of forms.

The embodiments are provided in order to explain the present invention to enable persons skilled in the art to implement the present invention more completely.

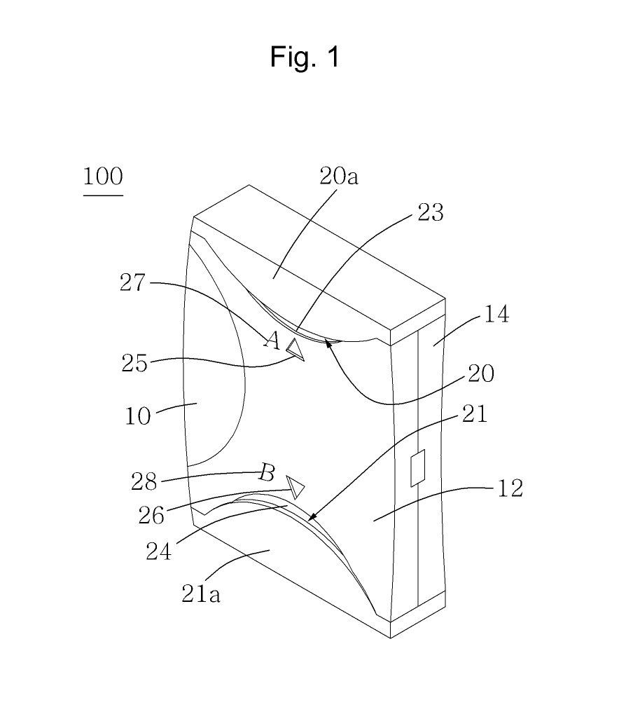

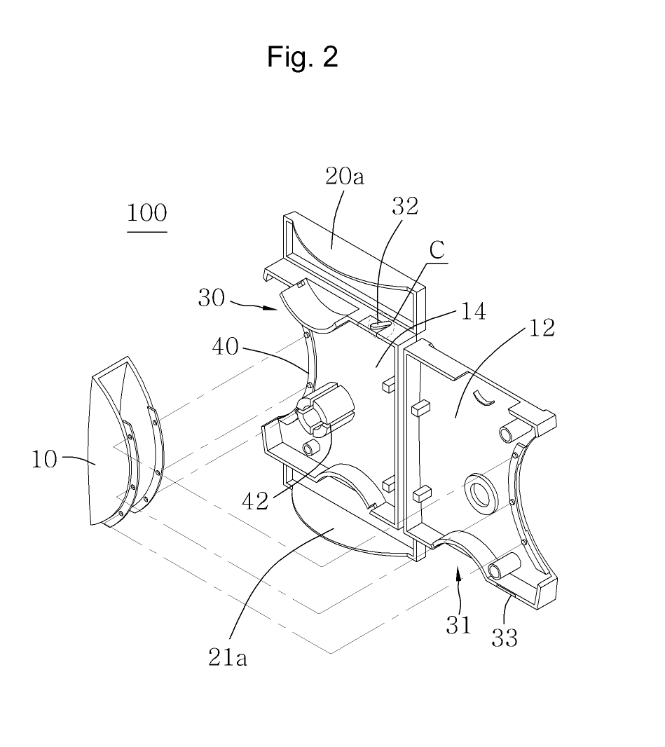

FIG. 1 is a frontal perspective view of a dental floss casing according to an embodiment of the present invention, and FIG. 2 is an exploded perspective view of the dental floss casing in which a front cover and a rear cover are opened, with the transparent window disconnected from the dental floss casing.

The dental floss casing 100 of the present invention is configured to accommodate more than one bobbin, e.g. two bobbins, together therein. In addition, the dental floss casing is configured such that the transparent window 10 is provided in one side of the front and rear covers 12 and 14 which are coupled together in order to enable a user to see into the dental floss casing from the outside. Here, the structure of the transparent window is such that it is assembled to and disassembled from the dental floss casing when the front and rear covers 12 and 14 are coupled with and decoupled from each other.

The front cover 12 has upper and lower dental floss-drawing sections 20 and 21 which are provided opposite to each other and through which the threads of dental floss are drawn out of the bobbins provided in the dental floss casing 10. The dental floss-drawing sections 20 and 21 are respectively provided with cover parts 20a and 21a that are pushed away in one side to open. Dental floss-holding parts 30 and 31 (FIG. 2) are respectively provided to the inside of the cover parts 20a and 21a in order to hold the thread of dental floss when it is drawn out of the bobbin.

Particularly, opening recesses 23 and 24 of a certain depth are respectively formed at inlets of the cover parts 20a and 21a that are pushed away to open, in order to allow a user to easily open and close the cover parts 20a and 21a. In addition, indicators 25 and 26 shaped like a triangle are respectively formed in one side of the opening recesses 23 and 24 in order to allow a user to easily recognize the position of the opening recesses to open the cover parts 20a and 21a.

In addition, markers 27 and 28 are respectively provided in one side of the indicators 25 and 26 in order to allow a user to easily identify the kind of dental floss that is drawn out of the bobbin provided in the casing. The marks 27 and 28 are marked with letters or figures. Further, dental floss cutters 32 and 33 (FIG. 2) are respectively provided in one side of the dental floss-drawing sections 20 and 21 in order to cut the thread of dental floss which is drawn through the dental floss-drawing section.

As shown in FIG. 2, while the dental floss casing 100 may be disassembled into the front cover 12, the rear cover 14, and the transparent window 10, the front cover 12 and the rear cover 14 may be formed from a sub-assembly in which the front and rear covers are fixedly coupled with each other at respective sides thereof, which facilitates the use thereof when replacing a bobbin with another bobbin.

In addition, unlike the conventional dental floss casing, which is formed in a gently rounded shape, which causes the problem of it being inconvenient for the user's thumb and index finger to enter the casing in order to hold the dental floss, because the shape cannot be suit to the varying thicknesses and sizes of users' fingers, the dental floss-holding sections 30 and 31 of the present invention, which are respectively provided to the inside of the cover parts 20a and 21a of the dental floss-drawing sections 20 and 21, are formed like an oval that protrudes higher than in the related art, so that it is easy for user's thumb and index finger to enter the casing and hold the thread of dental floss irrespective of the thickness and size of the user's finger.

In addition, the bobbin fixer 40 protrudes in the form of a cylinder to a certain length from an inner surface of either the front or rear cover 12 or 14 in order to accommodate therein all the plurality of bobbins wound with different kinds of threads of dental floss. The length is approximately two times the width of a bobbin that is conventionally used, and is preferably 3 to 5 cm. The bobbin fixer 40 formed like a cylinder is provided with a plurality of slits 42, which extends a certain length from its leading end towards the inner surface of the front or rear cover, to which the bobbin fixer is fixed, such that the slit bobbin fixer can contract and expand about its central axis.

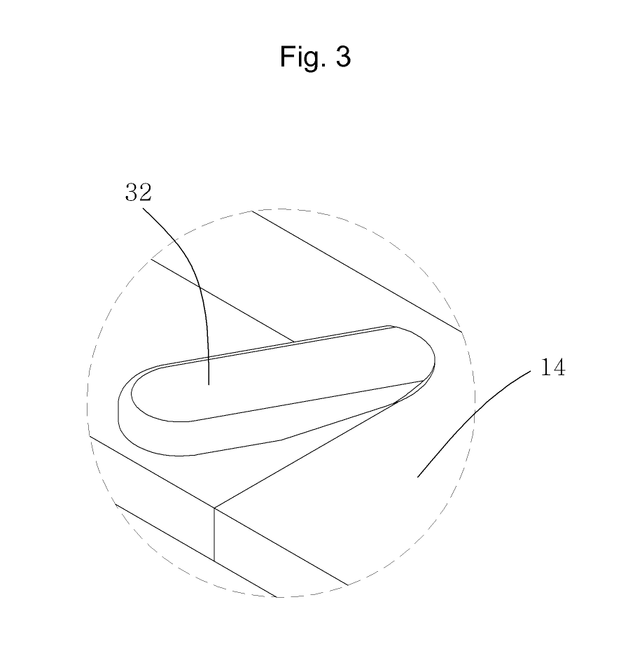

FIG. 3 is an enlarged view of section “C” of FIG. 2. As shown in FIG. 3, upper and lower dental floss cutters 32 and 33 are respectively provided in one side of the inside of the cover parts 20a and 21a of the dental floss-drawing sections 20 and 21 in order to cut the thread of dental floss that is being drawn. The upper and lower dental floss cutters 32 and 33 are provided in directions that are opposite to each other. Thus, even if a user uses the dental floss casing while turning it upside down in order to draw out a different kind of dental floss, the threads of dental floss are configured to be drawn and cut in the same direction of rotation. Particularly, the cutters 32 and 33 can use the same cutting blade, so that the manufacturing cost can be reduced and the working efficiency can be improved because of the use of shared parts.

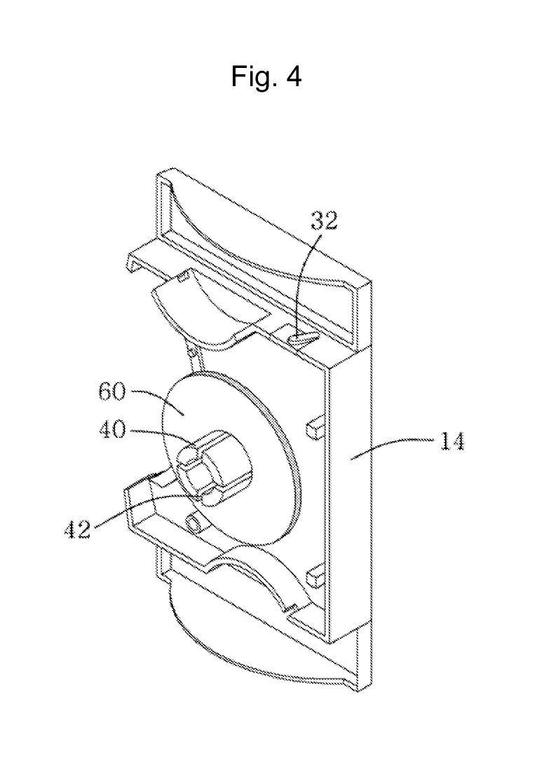

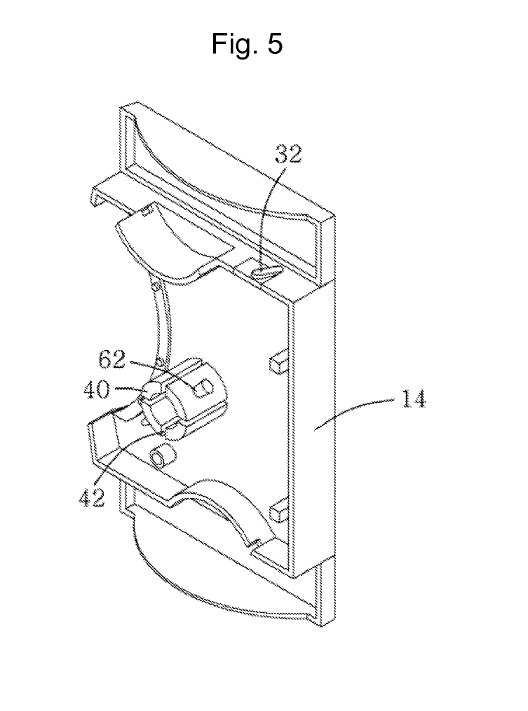

FIGS. 4 and 5 are views showing an anti-friction member 60 or 62 provided to the bobbin fixer 40 formed on the inner surface of the cover.

As described before, the length of the bobbin fixer 40 is sufficiently long so that two bobbins can be fitted together so that the threads of dental floss can be drawn therefrom. Here, the anti-friction member 60 or 62 is provided such that if the threads of dental floss are drawn from the two bobbins, it prevents friction between the two bobbins that are in contact with each other, the collapse of the wound state of the dental floss, and the entanglement of the threads of dental floss when they are being unwound.

The anti-friction member 60 or 62 is preferably formed of a circular disc having the same shape as the cylindrical bobbin, but the shape may be shapes other than a circle. In addition, a dividing pin formed at the center of the bobbin fixer 40 is fixedly coupled to the bobbin fixer, or otherwise is integrally formed with the bobbin fixer, thereby preventing the friction, entanglement, and collapse of the threads of dental floss when they are drawn from the adjacent bobbins.

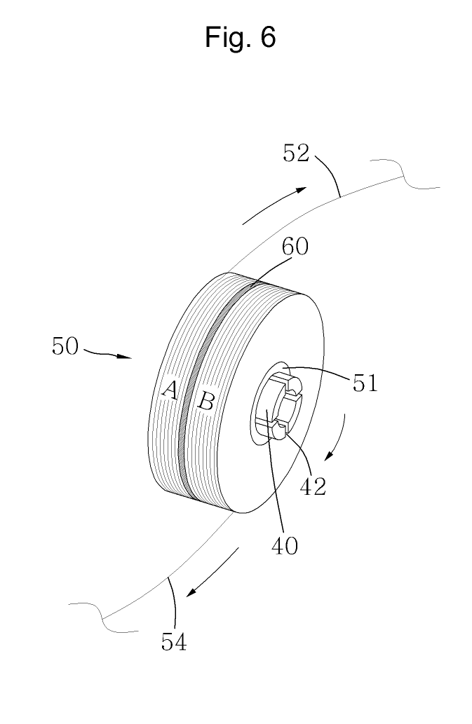

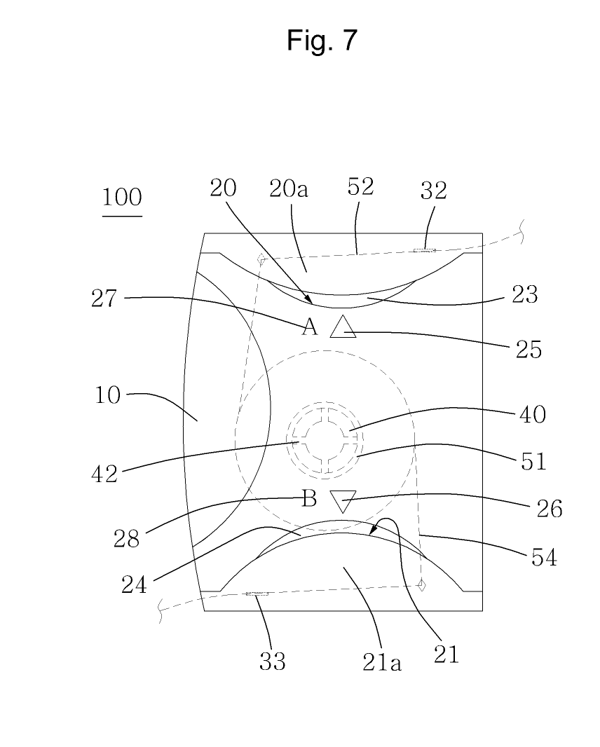

FIG. 6 is a view showing the state of the threads of dental floss 52 and 54 being drawn from two bobbins 50 and 52 fitted around the bobbin fixer 40, and FIG. 7 is a constructional view showing the state of the bobbins 50 and 51 wound with the threads of dental floss 52 and 54 that have been fitted around the bobbin fixer 40.

A shown in the figures, the dental floss cutters 32 and 33 are disposed adjacent the upper and lower dental floss-drawing sections 20 and 21 diagonal to each other. Thus, as shown in FIG. 6, even when different kinds of the threads of dental floss are unwound from the respective bobbins 50 and 51, the direction of rotation is the same, so that the respective bobbins 50 and 51 are smoothly rotated, and the friction and entanglement between the bobbins 50 and 51 facing each other are prevented by the anti-friction member 60. Thus, when the thread of dental floss is released from one of the bobbins, the other bobbin stays stopped, thereby preventing the thread of dental floss that is not at that time being used from being arbitrarily released from the inside of the casing.

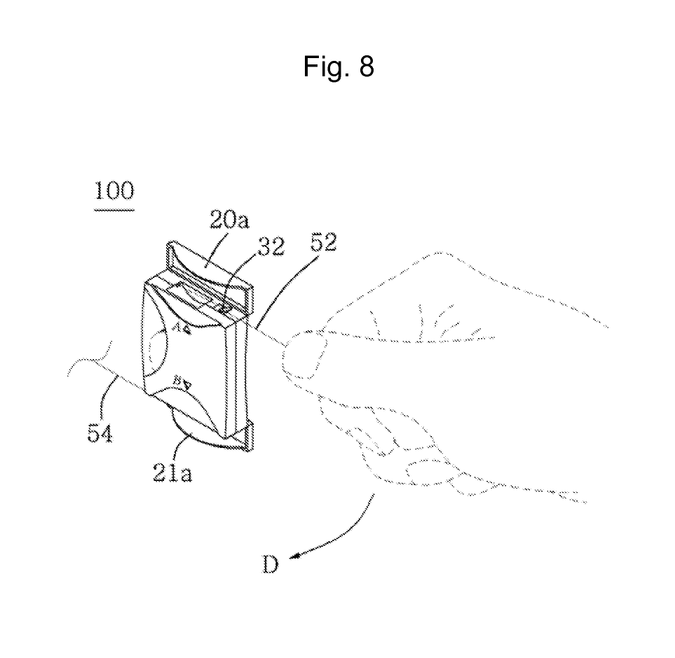

In addition, as shown in FIG. 8, when the thread of dental floss is drawn, a user holds a distal end of the dental floss and pulls out a required length of it. Then, the user uses the dental floss 52 after cutting it with the cutter 32 by pulling it in the direction of the arrow D.

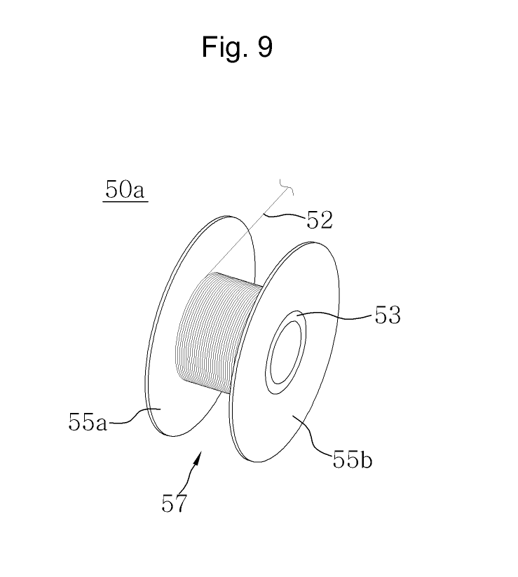

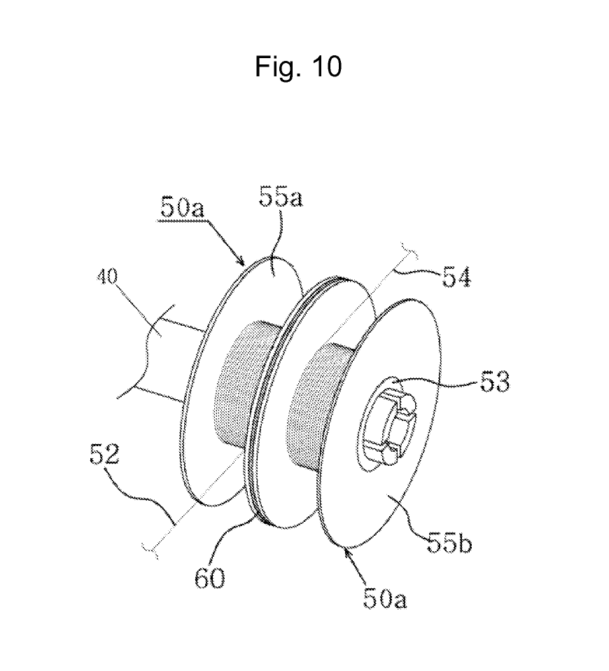

In the meantime, FIGS. 9 and 10 are perspective views showing a bobbin 50a that is mounted to the bobbin fixer 40 of the above-mentioned dental floss casing. As shown in FIG. 9, the bobbin 50a is configured so that sidewalls 55a and 55b are provided on opposite ends of a bobbin shaft 53, around which the thread of dental floss is wound. Here, the diameter of the sidewall may preferably be of 1.5 to 3 times the diameter of the bobbin shaft 53.

FIG. 10 shows the state of two bobbins 50a having the above construction being fitted around the bobbin fixer 40.

That is, the configuration is such that two bobbins 50a are fitted around the bobbin fixer 40 with different kinds of the threads 52 and 54 of dental floss wound around the respective bobbins 50a. Further, an anti-friction member 60 is more preferably mounted between the two bobbins so that even though two bobbins 50a, each having two sidewalls 55a and 55b, are concurrently mounted to the bobbin fixer 40, when the thread of dental floss is unwound from one bobbin, the other bobbin is prevented from rotating as may occur because the sidewalls of the two bobbins 50a are in contact with each other.

The anti-friction member 60 may be formed of a thin, slippery cellophane film.

The dental floss casing according to the present invention is conveniently used to store and organize dental floss which is used in a dental clinic or by a user to maintain the teeth healthy.

Particularly, two kinds of dental floss can be used in a single casing, and the manufacturing cost can be reduced by using common parts.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A dental floss casing comprising:
a bobbin fixer fixing therein a bobbin around which the thread of dental floss is wound; a transparent window coupled thereto for checking the state of the bobbin fitted around the bobbin fixer from the outside; front and rear covers detachably coupled to each other and around which the transparent window is provided; a dental floss-drawing section provided in one side of the front or rear cover such that the thread of dental floss wound around the bobbin is drawn to the outside therethrough; and a dental floss cutter provided adjacent to one side of the front or rear cover for cutting the thread of dental floss that is drawn, wherein a length of the bobbin fixer is from 3 to 5 cm such that more than one bobbins each wound with a different kind of dental floss are fitted together, and wherein the dental floss-drawing section and dental floss cutter respectively consist of a plurality of dental floss-drawing sections and dental floss cutters.

2. The dental floss casing according to claim 1, wherein a structure of the dental floss-drawing section and dental floss cutter is such that the dental floss-drawing section and the dental floss cutter are provided opposite to each other.

3. The dental floss casing according to claim 1, wherein the bobbin fixer is in a form of a cylinder with a plurality of slits formed at regular intervals along a circumference thereof such that when the bobbin is fitted around an outer circumference of the bobbin fixer, an inner surface of a fixing hole of the bobbin comes into elastic contact with the outer circumference of the bobbin fixer in order to prevent the bobbin fitted around the outer circumference of the bobbin fixer from idling when the thread of dental floss is drawn out.

4. The dental floss casing according to claim 3, wherein the dental floss-drawing section has a cover part, an opening recess of a certain depth is provided adjacent to one side of the cover part for facilitating opening the cover part, an indicator is provided adjacent to one side of the opening recess to indicate the position of opening the cover part, and a marker is provided adjacent to one side of the indicator to allow a user to identify the kind of dental floss wound around the bobbin.

5. The dental floss casing according to claim 4, wherein the bobbin fixer is provided, in the middle thereof in a lengthwise direction, with an anti-friction member to prevent friction between the plurality of bobbins fitted together therein when the dental floss is drawn.

6. The dental floss casing according to claim 5, wherein the anti-friction member includes one of a planar disc which is detachably coupled around the outer circumference of the bobbin fixer, and a dividing pin which is fitted into the outer circumference of the bobbin fixer.

7. The dental floss casing according to claim 2, wherein the bobbin fixer is in a form of a cylinder with a plurality of slits formed at regular intervals along a circumference thereof such that when the bobbin is fitted around an outer circumference of the bobbin fixer, an inner surface of a fixing hole of the bobbin comes into elastic contact with the outer circumference of the bobbin fixer in order to prevent the bobbin fitted around the outer circumference of the bobbin fixer from idling when the thread of dental floss is drawn out.

8. The dental floss casing according to claim 7, wherein the dental floss-drawing section has a cover part, an opening recess of a certain depth is provided adjacent to one side of the cover part for facilitating opening the cover part, an indicator is provided adjacent to one side of the opening recess to indicate the position of opening the cover part, and a marker is provided adjacent to one side of the indicator to allow a user to identify the kind of dental floss wound around the bobbin.

9. The dental floss casing according to claim 8, wherein the bobbin fixer is provided, in the middle thereof in a lengthwise direction, with an anti-friction member to prevent friction between the plurality of bobbins fitted together therein when the dental floss is drawn.

10. The dental floss casing according to claim 9, wherein the anti-friction member includes one of a planar disc which is detachably coupled around the outer circumference of the bobbin fixer, and a dividing pin which is fitted into the outer circumference of the bobbin fixer.

11. The dental floss casing according to claim 1, wherein the bobbin fixed to the bobbin fixer is provided with sidewalls on opposite ends of a bobbin shaft, around which the thread of dental floss is wound, wherein a diameter of the sidewall is larger than a diameter of the bobbin shaft.

12. The dental floss casing according to claim 5, wherein the bobbin fixed to the bobbin fixer is provided with sidewalls on opposite ends of a bobbin shaft, around which the thread of dental floss is wound, wherein a diameter of the sidewall is larger than a diameter of the bobbin shaft.

13. The dental floss casing according to claim 9, wherein the bobbin fixed to the bobbin fixer is provided with sidewalls on opposite ends of a bobbin shaft, around which the thread of dental floss is wound, wherein a diameter of the sidewall is larger than a diameter of the bobbin shaft.
